(19) United States
(12) Patent Application Publication
(10) Pub. No.: US 2026/0266341 A1
(43) Pub. Date: Sep. 10, 2026

(54) Dog Clutch Actuator and a Dog Clutch System Including the Same

(71) Applicants: HYUNDAI MOTOR COMPANY, Seoul (KR); KIA CORPORATION, Seoul (KR); Seoul National University R&DB Foundation, Seoul (KR)

(72) Inventors: Kyungsik Choi, Hwaseong-si (KR); Hoodam Lee, Hwaseong-si (KR); Taegyu Lee, Hwaseong-si (KR); Won Seok Lee, Hwaseong-si (KR); Hyungkwan Jang, Hwaseong-si (KR); Junhyeok Choi, Hwaseong-si (KR); Byung Ho Min, Hwaseong-si (KR); Yunkyung Ji, Hwaseong-si (KR); Sung-Hoon Ahn, Seoul (KR); Young-Uk Song, Seoul (KR); Deok Su Kim, Seoul (KR); Midum Oh, Seoul (KR); Semin Ahn, Seoul (KR)

(73) Assignees: HYUNDAI MOTOR COMPANY, Seoul (KR); KIA CORPORATION, Seoul (KR); Seoul National University R&DB Foundation, Seoul (KR)

(21) Appl. No.: 19/468,572

(22) Filed: Feb. 3, 2026

(30) Foreign Application Priority Data
Feb. 26, 2025 (KR) 10-2025-0024770

(51) Int. Cl. F16D 11/12

(52) U.S. Cl. CPC F16D 11/12

(57) ABSTRACT

A dog clutch actuator includes: a pull sleeve mounted on a shaft and movable in an axial direction to push or pull a dog clutch moving portion movably connected to the shaft in the axial direction; a base plate movably mounted to the pull sleeve; wedge blocks mounted on and radially movable relative to the base plate; a shape memory alloy wire connecting the base plate and the wedge blocks and configured to contract and expand depending on whether electric power is supplied to move the wedge blocks; a slider that is movably mounted to the pull sleeve and having cam contact with the wedge blocks so as to push the dog clutch moving portion and that is disposed between the wedge blocks and the dog clutch moving portion; and at least one actuator spring that elastically connects the base plate and the slider.

### CROSS-REFERENCE TO RELATED APPLICATION

This application claims priority to and the benefit of Korean Patent Application No. 10-2025-0024770 filed with the Korean Intellectual Property Office on Feb. 26, 2025, the entire contents of which are incorporated herein by reference.

### BACKGROUND

### (a) Field of the Disclosure

The present disclosure relates to a dog clutch actuator and a dog clutch system including the same, and more particularly, to a dog clutch actuator and system that may reduce weight, improve space utilization, and increase power delivery efficiency.

### (b) Description of the Related Art

A disconnector system, generally used in vehicles, is a device that separates or connects a motor and drive shaft depending on the driving conditions.

A four-wheel drive system of an electric vehicle includes a main drive wheel and an auxiliary drive wheel, and the disconnector system cuts off power to the auxiliary drive wheel. This may reduce unnecessary four-wheel drive and increase power efficiency by approximately 6-8%.

A typical disconnector system utilizes a rotation-type motor and a dog clutch type actuator including a ball screw. Rotation-type motors and ball screw type actuators have limitations in technological improvement in terms of weight, space utilization, and power delivery efficiency.

Alternatively, a solenoid actuator may be considered, but it has a limitation in that the power consumption must be large in order to obtain sufficient force.

The information contained in this background section is intended to promote understanding of the background of the disclosure and may include subject matter that is not conventional art already known to a person of ordinary skill in the field to which this technology belongs.

### SUMMARY

The present disclosure provides a dog clutch actuator capable of driving a dog clutch by supplying electric power to a shape memory alloy wire with a simple configuration. The present disclosure also provides a dog clutch system including the same.

A dog clutch actuator according to an embodiment of the present disclosure may include a pull sleeve movably mounted on a shaft and configured to be movable in an axial direction to push or pull a dog clutch moving portion movably connected to the shaft in the axial direction. The dog clutch actuator may also include a base plate that is movably mounted to the pull sleeve, wedge blocks mounted on and radially movable relative to the base plate, and a shape memory alloy wire that connects the base plate and the wedge blocks and that is configured to contract and expand depending on whether electric power is supplied to move the wedge blocks. The dog clutch actuator may further include a slider that is movably mounted to the pull sleeve, that has cam contact with the wedge blocks so as to push the dog clutch moving portion, and that is disposed between the wedge blocks and the dog clutch moving portion. The dog clutch actuator may also include at least one actuator spring that elastically connects the base plate and the slider.

The dog clutch actuator may further include pulleys rotatably mounted on each of the base plate and the wedge blocks on which the shape memory alloy wire is wound.

The dog clutch actuator may further include rail blocks that are connected to the base plate and radially slidable relative thereto.

Each of the wedge blocks may include a wedge body connected to a respective rail block and on which a pulley is rotatably mounted and may include a cam guide surface formed or provided to be inclined in a diagonal direction on the wedge body.

The pull sleeve may include a sleeve body of a cylinder shape that is slidably mounted on the shaft, a pull flange portion formed or provided at one end of the sleeve body and in contact with the dog clutch moving portion, and a support flange portion formed or provided at the other end of the sleeve body to push the base plate.

The slider may include a slide body that is slidably connected to the pull sleeve, a first shoulder portion formed or provided at one end of the slide body to push the dog clutch moving portion, a second shoulder portion formed or provided at the other end of the slide body, and a cam follow portion formed or provided on the second shoulder portion to cam contact with the wedge blocks.

The slider may include multiple cam follow portions, and each of the cam follow portions may include a cam follow surface that is in cam contact with a corresponding cam guide surface formed or provided on each of the wedge blocks.

The actuator spring may include a tensile coil spring fixed to the base plate and the slider.

The shape memory alloy wire may contract due to heat when power is supplied and may expand due to cooling when the power supply is cut off.

A dog clutch system according to an embodiment of the present disclosure may include a dog clutch housing connected to a first shaft and having a first gear formed or provided therein and a dog clutch moving portion movably connected to a second shaft arranged coaxially with the first shaft and having a second gear selectively engaging the first gear. The dog clutch system may also include the dog clutch actuator installed on the second shaft.

The first gear may be a housing clutch dog formed or provided on the inner periphery of the dog clutch housing.

The second gear may be a moving portion clutch formed or provided on the exterior circumference of the dog clutch moving portion.

The dog clutch moving portion may include a flange pulling edge that contacts the pull sleeve of the dog clutch actuator.

The dog clutch system may further include a clutch fixing unit installed on the dog clutch moving portion to limit the movement of the dog clutch moving portion when the first gear and the second gear are engaged.

The clutch fixing unit may include a locking groove formed or provided on the exterior circumference of the second shaft, and at least one anchor selectively insertable into the locking groove.

The at least one anchor may reside in a slot formed or provided, i.e., disposed along the length direction of the pull sleeve of the dog clutch actuator.

The clutch fixing unit may further include an anchor housing fixed to the dog clutch moving portion, and an anchor spring disposed in the anchor housing to elastically support at least one anchor.

The dog clutch system may further include a base fixing portion installed in a system housing of the dog clutch system to selectively fix the base plate of the dog clutch actuator. The dog clutch system may also include a slider fixing portion installed in the system housing to selectively fix the slider of the dog clutch actuator.

The base fixing portion may include a base fixing block, which is selectively movable into at least one base fixing groove formed or provided in the exterior circumference of the base plate and which is movably mounted in at least one base fixing case fixed to the system housing. The base fixing portion may also include a shape memory alloy spring connected to the base fixing case and the base fixing block. The shape memory alloy spring may be placed inside the base fixing case and may be configured to contract and expand depending on whether power is supplied.

The slider fixing portion may include a slider fixing block, which is selectively inserted into at least one slider fixing groove formed or provided in the exterior circumference of the slider and which is movably mounted in at least one slider fixing case fixed to the system housing. The slider fixing portion may also include a spring that is disposed inside the slider fixing case and connected to the slider fixing case and the slider fixing block.

According to an embodiment of a dog clutch actuator and a dog clutch system including the same, the dog clutch actuator has a simple configuration and has a relatively small and light weight can be implemented.

In addition, according to an embodiment of a dog clutch actuator and a dog clutch system including the same, an enhancement of fuel efficiency is possible because no additional power is required to maintain the engagement of the clutch by applying a fixing portion.

In addition, the effects that can be obtained or expected from embodiments of the present disclosure are disclosed directly or implicitly in the detailed description provided below. In other words, various effects predicted according to embodiments of the present disclosure will be disclosed in the detailed description to be provided later.

### BRIEF DESCRIPTION OF THE DRAWINGS

The drawings are intended for reference in explaining embodiments of the present disclosure. Therefore, the technical ideas of the present disclosure should not be construed as being limited to the accompanying drawings.

FIG. 1 is a cross-sectional view illustrating a dog clutch system according to an embodiment of the present disclosure.

FIG. 2 is a perspective view illustrating a dog clutch actuator according to an embodiment of the present disclosure.

FIG. 3 is a cross-sectional view illustrating a dog clutch actuator according to an embodiment of the present disclosure.

FIGS. 4A and 4B are perspective views illustrating a pull sleeve applied to a dog clutch actuator according to an embodiment of the present disclosure.

FIG. 5 is a drawing showing a base plate applied to a dog clutch actuator according to an embodiment of the present disclosure.

FIG. 6 is a perspective view illustrating a wedge block applied to a dog clutch actuator according to an embodiment of the present disclosure.

FIG. 7 is a drawing showing a mounting structure of a wedge block and a pulley applied to a dog clutch actuator according to an embodiment of the present disclosure.

FIGS. 8A, 8B, and 8C are drawings showing a slider applied to a dog clutch actuator according to an embodiment of the present disclosure.

FIGS. 9-11 are drawings showing a clutch fixing unit applied to a dog clutch system according to an embodiment of the present disclosure.

FIGS. 12A and 12B are drawings showing a base fixing portion applied to a dog clutch system according to an embodiment of the present disclosure.

FIGS. 13A and 13B are drawings showing a slider fixing portion applied to a dog clutch system according to an embodiment of the present disclosure.

FIGS. 14-17 are drawings for describing the operation of a dog clutch actuator and a dog clutch system including the same according to an embodiment of the present disclosure.

The drawings referenced above are not necessarily to drawn scale but should be understood as presenting rather simplified representations of various features illustrating the basic principles of the present disclosure. For example, certain design features of the present disclosure, including particular dimensions, direction, position, and shape, will be determined in part by the particular intended application and usage environment.

### DETAILED DESCRIPTION OF THE EMBODIMENTS

The terminology used herein is for the purpose of describing particular embodiments and is not intended to limit the disclosure.

As used in this specification, the singular forms are intended to also include the plural forms, unless the context clearly indicates otherwise.

It should also be understood that the terms ‘including,’ ‘having,’ and/or ‘comprising’ as used in this specification indicate the presence of specified features, integers, steps, operations, elements and/or components. Such do not preclude the presence or addition of one or more other features, integers, steps, operations, components, and/or groups thereof.

As used in this specification, the term ‘and/or’ includes any one or all combinations of one or more of the associated listed items.

In this specification, the term ‘connected’ indicates a physical relationship between two components where the components are directly connected to each other or indirectly connected through one or more intermediary components.

Additionally, terms such as “element”, “part”, “unit”, or the like, described in the specification, mean a comprehensive unit that performs at least one function or operation. Further, when a part, component, device, unit, module, controller, element, or the like of the present disclosure is described as having a purpose or performing an operation, function, or the like, the part, component, device, unit, module, controller, or element should be considered herein as being “configured to” meet that purpose or to perform that operation or function. The present disclosure describes a dog clutch actuator and system that may include a controller for operating or controlling aspects thereof. The controller or other such components may separately embody or be included with a processor and a memory, such as a non-transitory computer readable media, as part of the controller or component.

The terms “vehicle”, “car”, “vehicular” or other similar terms used in this specification include vehicles in general. Such vehicles may include sports utility vehicles (SUVs), buses, trucks, passenger vehicles including various commercial vehicles, ships, various types of boats and vessels, aircraft and the like. Such vehicles may also include hybrid vehicles, electric vehicles, plug-in hybrid electric vehicles, hydrogen fuel vehicles and other alternative fuel (e.g., fuel obtained from resources other than petroleum) vehicles.

Hereinafter, embodiments of the present disclosure are described in detail with reference to the accompanying drawings.

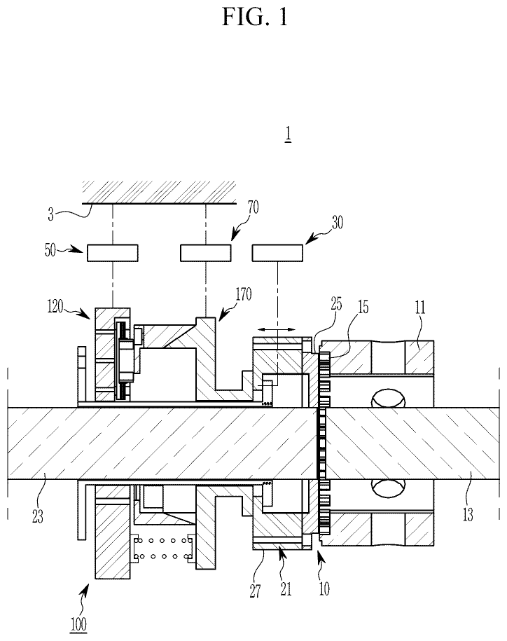

FIG. 1 is a cross-sectional view illustrating an embodiment of a dog clutch system 1 according to the present disclosure.

Referring to FIG. 1, a dog clutch system 1 according to an embodiment of the present disclosure can be applied to, for example, a four-wheel drive system of an electric vehicle.

The dog clutch system 1 may include a dog clutch 10, a dog clutch actuator 100, and a clutch fixing unit 30.

A dog clutch (also called a dog box, a dog gear, a dog ring, a clutch dog, or a positive clutch) is a type of clutch that connects two rotation shafts or other rotation components through engagement of interlocking teeth or dogs rather than friction.

The two parts of the clutch engage each other by engaging against each other and are designed to rotate at the same speed and not slip. Here, the dog is a tool or device used to lock two components to each other.

By taking advantage of these characteristics, dog clutches are used, for example, in transmissions to engage different gears to rotate the input shaft and output shaft.

A four-wheel drive system of an electric vehicle includes a main drive wheel and an auxiliary drive wheel. A disconnector system serves to cut off power between the auxiliary drive wheel and the wheels. This may reduce unnecessary four-wheel drive and increase power efficiency by approximately 6-8%.

The rotation type motor and ball screw type actuator applied to a general disconnector system have limitations in technological improvement in terms of weight, space utilization, and power delivery efficiency.

When applying a solenoid actuator, the power consumption may increase in order to obtain sufficient force.

The dog clutch actuator and system according to the disclosed embodiments have a simple configuration. Thus, a relatively small and light dog clutch actuator and system including the same may be implemented.

In this specification, the reference directions for describing the components below can be set as the axial direction, the radial direction perpendicular to the axial direction (or radial direction), and the vertical direction when referring to the drawings.

In this specification, the ‘top’, ‘upper’, or ‘upper face’ of a component refers to an end, section, or face of the component that is relatively higher in the drawing, and the ‘bottom’, ‘lower’, or ‘lower face’ of a component refers to an end, section, or face of the component that is relatively lower in the drawing.

In this specification, a terminus of a component (e.g., one end or the other end) refers to an end of the component in any one direction, and an end portion of a component (e.g., one end or the other end) refers to a portion of the component that includes that terminus or end.

The dog clutch 10 applicable to the dog clutch system 1 according to a disclosed embodiment may include a dog clutch housing 11 and a dog clutch moving portion 21.

The dog clutch housing 11 is connected to a first shaft 13, and a first gear 15 may be formed or provided in the dog clutch housing 11. For example, the first gear 15 may be formed or provided on an inner periphery of the dog clutch housing 11.

The dog clutch moving portion 21 may be movably connected along the axial direction to a second shaft 23 arranged coaxially with the first shaft 13.

The dog clutch moving portion 21 may include a second gear 25 that selectively engages the first gear 15 of the dog clutch housing 11.

The first gear 15 may be a housing clutch dog formed or provided on the inner circumference of the dog clutch housing 11, and the second gear 25 may be a moving portion clutch dog formed or provided on an exterior circumference of the dog clutch moving portion 21.

The dog clutch housing 11 and the first shaft 13 may be connected, for example, with a bolt and a helical gear. The combination of the dog clutch housing 11 and the first shaft 13 should be known or apparent to those of ordinary skill in the art, so a detailed description thereof has been omitted.

The dog clutch moving portion 21 and the second shaft 23 are connected to enable axial direction movement. For example, a spline or serration is formed or provided on the inner circumference of the dog clutch moving portion 21 and the exterior circumference of the second shaft 23, so that the dog clutch moving portion 21 and the second shaft 23 perform the same rotation and enable relative axial direction movement.

As shown in FIG. 1, an outer gear 27 may be configured to transmit power to other components of the disconnector system. The connection and function of outer gear 27 of the disconnector system should be known or apparent to those of ordinary skill in the art, so a detailed description thereof has been omitted.

The dog clutch actuator 100 according to an embodiment is configured to drive the dog clutch 10.

The dog clutch actuator 100 can push or pull the dog clutch moving portion 21 and move the dog clutch moving portion 21 in the axial direction along the second shaft 23

When the dog clutch actuator 100 pushes the dog clutch moving portion 21 in the axial direction along the second shaft 23, the first gear 15 of the dog clutch housing 11 and the second gear 25 of the dog clutch moving portion 21 are engaged, and the dog clutch housing 11 and the dog clutch moving portion 21 can be connected to each other.

When the dog clutch actuator 100 pulls the dog clutch moving portion 21 in the axial direction along the second shaft 23, the first gear 15 of the dog clutch housing 11 and the second gear 25 of the dog clutch moving portion 21 are separated, and the engagement of the dog clutch housing 11 and the dog clutch moving portion 21 can be released.

The dog clutch actuator 100 according to an embodiment is installed on the second shaft 23. The configurations of the dog clutch actuator 100 are described in further detail below.

In a disclosed embodiment, the clutch fixing unit 30 is configured to limit movement of the dog clutch moving portion 21 when the first gear 15 of the dog clutch housing 11 and the second gear 25 of the dog clutch moving portion 21 are engaged.

The clutch fixing unit 30 is installed on the dog clutch moving portion 21. The configurations of the clutch fixing unit 30 according to a disclosed embodiment of the present disclosure are described in further detail below.

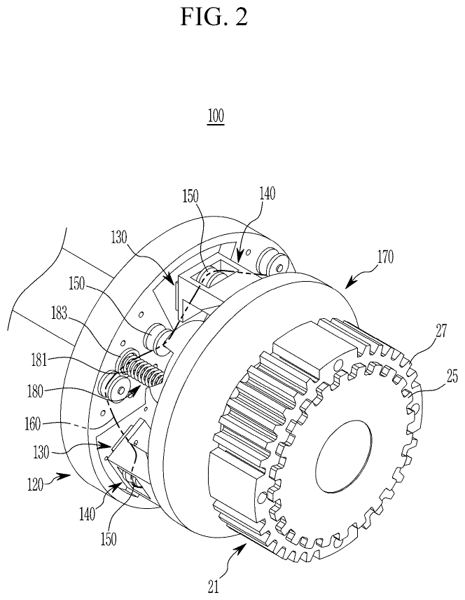

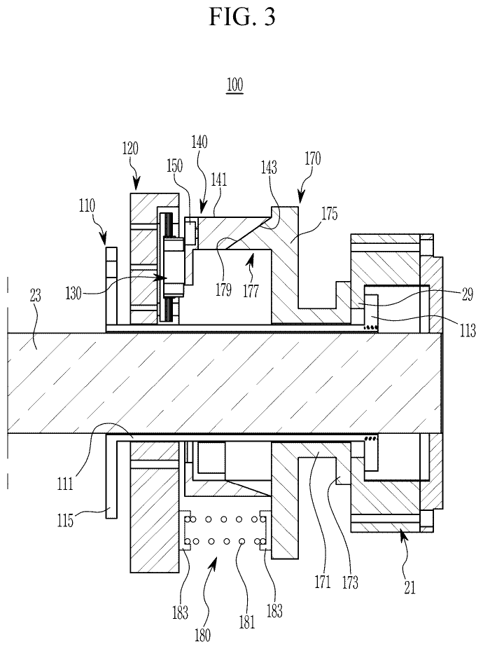

FIG. 2 is a perspective view illustrating a dog clutch actuator 100 according to an embodiment of the present disclosure. FIG. 3 is a cross-sectional view illustrating a dog clutch actuator 100 according to an embodiment.

Referring to FIGS. 1-3, the dog clutch actuator 100 according to an embodiment may include a pull sleeve 110, a base plate 120, rail blocks 130, wedge blocks 140, pulleys 150, a shape memory alloy wire 160, a slider 170, and at least one actuator spring 180.

In an embodiment of the present disclosure, the pull sleeve 110 is configured to push or pull the dog clutch moving portion 21 of the dog clutch 10 in the axial direction along the second shaft 23.

The pulling direction here is defined as another direction that separates the dog clutch moving portion 21 from the dog clutch housing 11 to disengage the dog clutch moving portion 21 from the dog clutch housing 11.

The pull sleeve 110 is movably mounted in the axial direction on the second shaft 23 and can be connected to the dog clutch moving portion 21.

The pull sleeve 110 is provided in a cylinder shape and can be fitted along the axial direction to the exterior circumference of the second shaft 23. The interior circumference of the pull sleeve 110 can be slidably contacted with, i.e., engage the exterior circumference of the second shaft 23.

The pull sleeve 110 is slidably connected to the second shaft 23 along the axial direction and can be slidably connected to the dog clutch moving portion 21 that rotates by the second shaft 23.

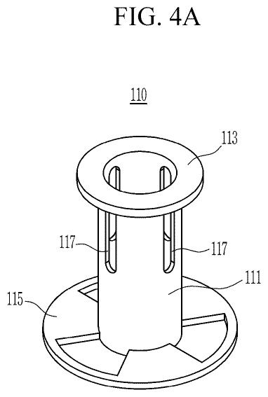

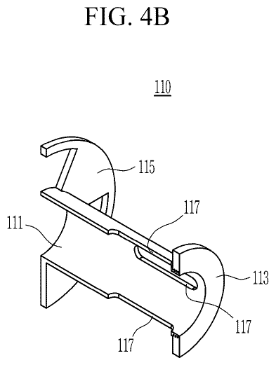

FIGS. 4A and 4B are perspective views illustrating a pull sleeve 110 applied to a dog clutch actuator 100 according to the disclosed embodiment.

Referring to FIGS. 4A and 4B, the pull sleeve 110 may include a sleeve body 111, a pull flange portion 113, and a support flange portion 115.

The sleeve body 111 is slidably mounted on the second shaft 23 and can be provided in a cylinder shape with both ends open.

The pull flange portion 113 is formed or provided at one end of the sleeve body 111 and can come into contact with the dog clutch moving portion 21.

The pull flange portion 113 can come into contact with a flange pulling edge 29 formed or provided on the dog clutch moving portion 21. The support flange portion 115 is configured to slide the base plate 120, which is further described below. The support flange portion 115 is formed or provided at the other end of the sleeve body 111.

The pull sleeve 110 according to an embodiment of the present disclosure includes at least one slot 117 formed or provided, i.e., disposed along the length direction. For example, the at least one slot 117 may be formed or provided in multiples (e.g., four) along the length direction of the sleeve body 111. The length direction here refers to the axial direction of the first shaft 13 and the second shaft 23, which is the same direction as the moving direction of the dog clutch moving portion 21.

In an embodiment of the present disclosure, referring to FIGS. 1-3, the base plate 120 is mounted relatively movably along the axial direction of the second shaft 23 on the pull sleeve 110.

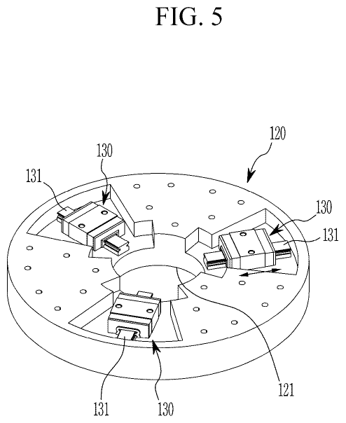

FIG. 5 is a drawing showing a base plate 120 applied to a dog clutch actuator 100 according to a disclosed embodiment.

The base plate 120 may be provided as a circular plate, as shown in FIG. 5, in one example. The base plate 120 can be fitted along the axial direction of the second shaft 23 to the exterior circumference of the pull sleeve 110 through a connection hole 121 formed or provided in the center of the base plate 120.

In an embodiment of the present disclosure, the rail blocks 130, as shown in FIG. 5, can be slidably mounted in the radial direction on the base plate 120.

The rail blocks 130 can be radially slidably connected to guide rails 131 fixed along the radial direction to the base plate 120.

In an embodiment of the present disclosure, referring to FIGS. 1-3, the wedge blocks 140 can be slidably mounted in the radial direction to the base plate 120.

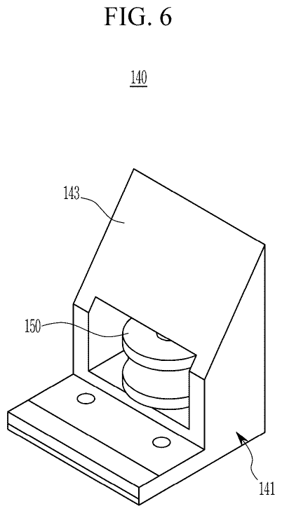

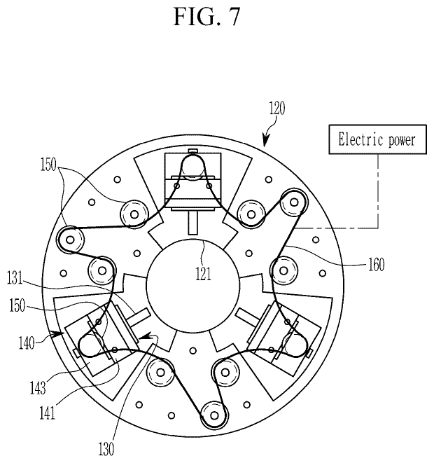

FIG. 6 is a perspective view illustrating a wedge block 140 applied to a dog clutch actuator 100 according to an embodiment of the present disclosure. FIG. 7 is a drawing showing a mounting structure of a wedge block 140 and a pulley 150 applied to a dog clutch actuator 100 according to an embodiment.

Referring to FIGS. 1-7, the wedge blocks 140 are connected to the rail blocks 130. Each of these wedge blocks 140 may include a wedge body 141 and a cam guide surface 143.

The wedge body 141 can be engaged to the rail blocks 130 by fastening members, which may be for example bolts and nuts.

The cam guide surface 143 is formed or provided to be inclined in a diagonal direction to the wedge body 141. The cam guide surface 143 can be formed or provided as a sloped surface having a shape whereby a cross-section increases in the direction of the dog clutch moving portion 21 toward the dog clutch housing 11, for example.

In an embodiment of the present disclosure, the pulleys 150 can be rotatably mounted on each of the base plate 120 and the wedge blocks 140.

The pulleys 150 are arranged in a dispersion pattern on the base plate 120, centered on the connection hole 121 of the base plate 120. The pulleys 150 are each rotatably mounted on the wedge body 141 of the wedge blocks 140.

In an embodiment of the present disclosure, the shape memory alloy wire 160 is configured to connect the base plate 120 and the wedge blocks 140.

The shape memory alloy wire 160 can contract and expand depending on whether electric power is supplied to move the wedge blocks 140.

A shape memory alloy is an alloy that has the characteristic of being deformable and returning to its original shape due to a phase transformation (e.g., change in lattice structure) that occurs at a specific temperature. Depending on the composition of the alloy, the phase transformation temperature can be controlled, and the strain limit and recovery stress due to recovery can be determined depending on the post-processing.

The shape memory alloy wire 160 can contract by heat when power is supplied and expand by cooling when power supply is cut off. The shape memory alloy wire 160 can be connected to a cable that supplies power.

When power is supplied to the shape memory alloy wire 160, the shape memory alloy wire 160 is heated by the ‘Joule’ heat generated by the current and can contract due to a phase transformation caused by a temperature change.

Additionally, when the power applied to the shape memory alloy wire 160 is cut off, the shape memory alloy wire 160 is cooled and may expand due to phase transformation caused by a temperature change.

The shape memory alloy wire 160 is provided in the form of a loop of a predetermined length and is wound around the pulleys 150 mounted on the base plate 120 and the wedge blocks 140.

The length of the shape memory alloy wire 160 can be selectively set according to the current required to deform the shape memory alloy wire 160, the required movement distance of the dog clutch moving portion 21, and the force and time required for engagement and release of the dog clutch moving portion 21 and the dog clutch housing 11, respectively.

The number and diameter of the pulleys 150 on which the shape memory alloy wire 160 is wound are not limited to the configuration shown in the drawings or to any specific values. For example, the number and diameter of pulleys 150 can be determined based on the force required for engagement and release of the dog clutch moving portion 21 and the dog clutch housing 11, respectively, the strain rate and required length of the shape memory alloy wire 160, and/or the like.

Referring to FIGS. 1-3, in an embodiment of the present disclosure, the slider 170 is configured to push the dog clutch moving portion 21. Additionally, the slider 170 is configured to support the dog clutch moving portion 21 when the dog clutch moving portion 21 is pulled by the pull sleeve 110.

The slider 170 can be movably mounted to the pull sleeve 110 so as to make cam contact with the wedge blocks 140. The slider 170 can be placed between the wedge blocks 140 and the dog clutch moving portion 21 so as to push the dog clutch moving portion 21.

The direction of the movement is defined as the direction that brings the dog clutch moving portion 21 adjacent to the dog clutch housing 11 so as to join the dog clutch moving portion 21 and the dog clutch housing 11.

The slider 170 can be fitted along the length direction of the pull sleeve 110 to the exterior circumference of the pull sleeve 110. The interior circumference of the slider 170 can be slidably contacted, i.e., engage with the exterior circumference of the pull sleeve 110.

The slider 170 can be in contact with or spaced from the dog clutch moving portion 21, which rotates by the second shaft 23.

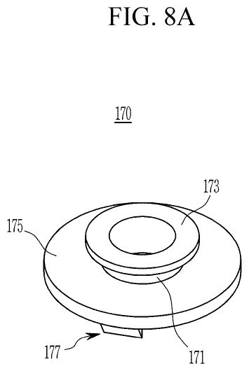

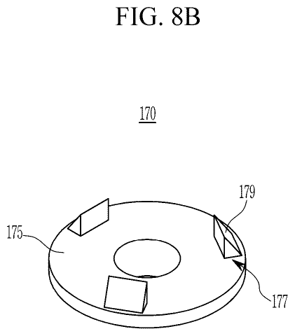

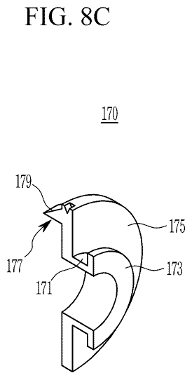

FIGS. 8A, 8B, and 8C are drawings showing a slider 170 applied to a dog clutch actuator 100 according to an embodiment.

The slider 170 may include a slide body 171, a first shoulder portion 173, a second shoulder portion 175, and cam follow portions 177, as illustrated in FIG. 3 and FIGS. 8A, 8B, and 8C.

The slide body 171 is connected to the pull sleeve 110 in a sliding manner. The first shoulder portion 173 is formed or provided in a flange shape protruding from one end of the slide body 171 to support the dog clutch moving portion 21. The second shoulder portion 175 is formed or provided in a flange shape protruding from the other end of the slide body 171.

The cam follow portions 177 are formed or provided on the second shoulder portion 175 to make cam contact with the wedge blocks 140.

Each of the cam follow portions 177 may include a cam follow surface 179 that is configured to make cam contact with the cam guide surface 143 of the wedge blocks 140.

The cam follow surface 179 is formed or provided to be inclined in a diagonal direction on each of the cam follow portions 177. The cam follow surface 179 can be formed or provided as a sloped surface with a decreasing cross-section in the direction of the dog clutch housing 11 from the base plate 120 side, for example.

The inclination angle of the cam guide surface 143 and the cam follow surface 179 that make surface contact can be determined according to the force required to engage and disengage the dog clutch moving portion 21 and the dog clutch housing 11, respectively, and the required movement distance of the dog clutch moving portion 21.

Referring to FIGS. 2 and 3, in an embodiment of the present disclosure, the at least one actuator spring 180 is configured to elastically support the base plate 120 and the slider 170 with wedge blocks 140 therebetween.

The drawing shows one actuator spring 180. However, for example, two or more actuator springs 180 may be provided. The number of actuator springs 180 can be determined according to the force required to engage and disengage the dog clutch moving portion 21 and the dog clutch housing 11, respectively.

The at least one actuator spring 180 may include a tensile coil spring 181 fixed to the base plate 120 and the slider 170.

The two ends of the at least one actuator spring 180 can each be fixed to spring seats 183. The spring seats 183 can be fixed to the base plate 120 and the slider 170 respectively.

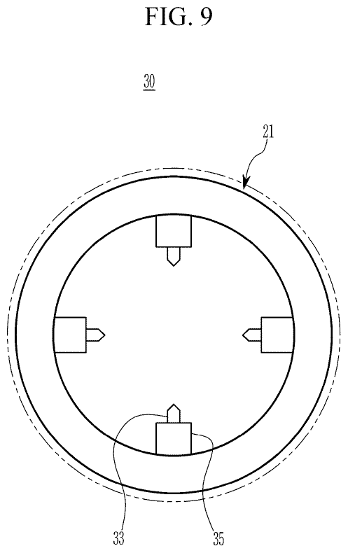

FIGS. 9-11 are drawings showing a clutch fixing unit 30 applied to a dog clutch system 1 according to the disclosed embodiment.

Referring to FIGS. 1-11, the clutch fixing unit 30 according to an embodiment can be installed in multiple on the dog clutch moving portion 21. The drawings show the clutch fixing units 30 radially arranged in four positions but the disclosure is not limited thereto.

Each of the clutch fixing units 30 according to an embodiment of the present disclosure may include a locking groove 31 formed or provided in the exterior circumference of the second shaft 23 and may include at least one anchor 33 selectively inserted into the respective locking groove 31.

Each of the clutch fixing units 30 may further include an anchor housing 35 fixed to the dog clutch moving portion 21 and an anchor spring 37 inserted into the anchor housing 35 to elastically support at least one anchor 33.

The locking groove 31 is formed or provided along the circumferential direction of the exterior circumference of the second shaft 23. Although the drawings show that two locking grooves 31 are provided, this is not a limitation. One or three or more locking grooves 31 may be formed or provided as required to secure the dog clutch moving portion 21.

The at least one anchor 33 can be provided to protrude from the inside of the dog clutch moving portion 21 accessible to the exterior circumference of the second shaft 23. The at least one anchor 33 can contact the exterior circumference of the second shaft 23 and be inserted into the locking groove 31.

The anchor housing 35 can be connected to the inner side of the dog clutch moving portion 21, for example, to the flange pulling edge 29.

The at least one anchor 33 may protrude from the inside to the outside of the anchor housing 35.

The anchor spring 37 is disposed inside the anchor housing 35 and elastically supports the anchor 33. The anchor spring 37 may, in one example, include a compression coil spring.

At least one anchor 33 can be disposed at a position corresponding to at least one slot 117 formed or provided in the pull sleeve 110.

As the dog clutch moving portion 21 moves along the axial direction of the second shaft 23, at least one anchor 33 can be guided along at least one slot 117 to contact the exterior circumference of the second shaft 23 and can be connected to the locking groove 31.

Referring to FIG. 1, the dog clutch system 1 according to an embodiment may further include a base fixing portion 50 and a slider fixing portion 70.

In an embodiment of the present disclosure, the base fixing portion 50 is configured to selectively fix the base plate 120 of the dog clutch actuator 100 to the system housing 3.

The slider fixing portion 70 is configured to selectively fix the slider 170 of the dog clutch actuator 100 to the system housing 3.

The system housing 3 is fixed to a vehicle body, and the dog clutch system 1 according to disclosed embodiment can be configured inside the system housing 3.

The base fixing portion 50 can be installed in the system housing 3 at a position corresponding to the base plate 120.

The slider fixing portion 70 can be installed in the system housing 3 at a position corresponding to the slider 170.

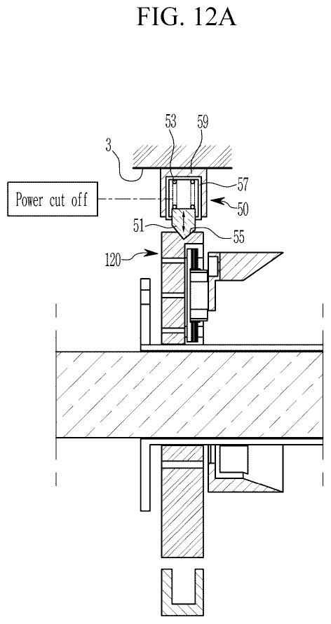

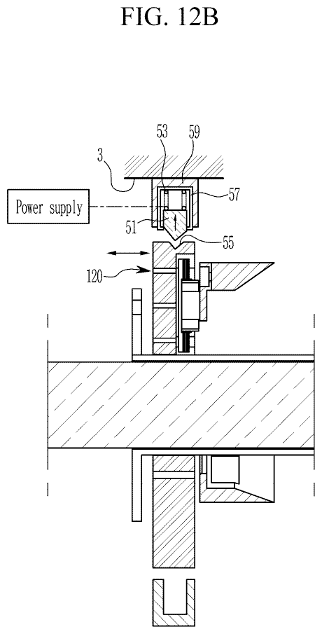

FIGS. 12A and 12B are drawings showing a base fixing portion 50 applied to a dog clutch system 1 according to an embodiment.

Referring to FIGS. 12A and 12B, the base fixing portion 50 according to an embodiment of the present disclosure may include at least one base fixing block 51 and a shape memory alloy spring 53.

The at least one base fixing block 51 can be selectively connected to at least one base fixing groove 55 formed or provided in the exterior circumference of the base plate 120.

The at least one base fixing block 51 is movably mounted in at least one base fixing case 57, which is fixed to the system housing 3.

The fixing block 51 can be moved along the diameter direction of the base plate 120.

The base fixing case 57 can be fixed to a ring-shaped case fixing member 59 connected to the system housing 3.

Each of the at least one base fixing groove 55, the at least one base fixing case 57, and the at least one base fixing block 51 may be provided in a quantity of one or in quantities of two or more, for example, as required to fix the base plate 120.

The shape memory alloy spring 53 is provided as a spring type shape memory alloy. The shape memory alloy spring 53 can contract and expand depending on whether electric power is supplied to move the base fixing block 51.

The shape memory alloy spring 53 is disposed inside the base fixing case 57 and is connected to the fixing case 57 and the base fixing block 51.

The shape memory alloy spring 53 generates ‘Joule’ heat when power is supplied, contracts due to the generated heat, and expands due to cooling when the power supply is cut off. The shape memory alloy spring 53 can be connected to a cable that supplies power.

When power is supplied to the shape memory alloy spring 53 and the shape memory alloy spring 53 contracts, the base fixing block 51 moves inwardly of the base fixing case 57 and can be separated or released from the base fixing groove 55.

When the power supplied to the shape memory alloy spring 53 is cut off and the shape memory alloy spring 53 expands, the base fixing block 51 moves in the outward direction of the base fixing case 57 and can be connected to the base fixing groove 55.

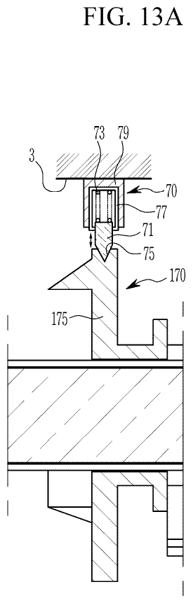

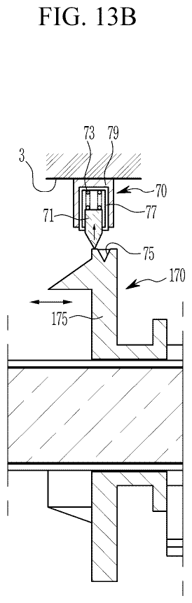

FIGS. 13A and 13B are drawings showing a slider fixing portion 70 applied to a dog clutch system 1 according to an embodiment.

Referring to FIGS. 13A and 13B, the slider fixing portion 70 according to an embodiment of the present disclosure may include at least one slider fixing block 71 and a spring 73.

The at least one slider fixing block 71 can be selectively connected to at least one slider fixing groove 75 formed or provided in the exterior circumference of the second shoulder portion 175 of the slider 170.

The slider fixing block 71 is movably mounted in a slider fixing case 77 fixed to the system housing 3.

The slider fixing block 71 can be moved along the diameter direction of the second shoulder portion 175 of the slider 170.

The slider fixing case 77 can be fixed to a ring-shaped case fixing member 79 connected to the system housing 3.

Each of the at least one slider fixing groove 75, the at least one slider fixing case 77, and the at least one slider fixing block 71 may be provided in a quantity of one or in quantities of two or more as required to fix the slider 170, for example.

The spring 73 may be provided as a compression coil spring to move the slider fixing block 71.

The spring 73 is disposed inside the slider fixing case 77 and is connected to the slider fixing case 77 and the slider fixing block 71.

The slider fixing block 71 moves inwardly of the slider fixing case 77 while compressing the spring 73 and can come into contact with the exterior circumference of the second shoulder portion 175 while being separated or released from the slider fixing groove 75.

The slider fixing block 71 is moved in the outward direction of the slider fixing case 77 by the elastic restoring force of the spring 73 and may be connected to the slider fixing groove 75.

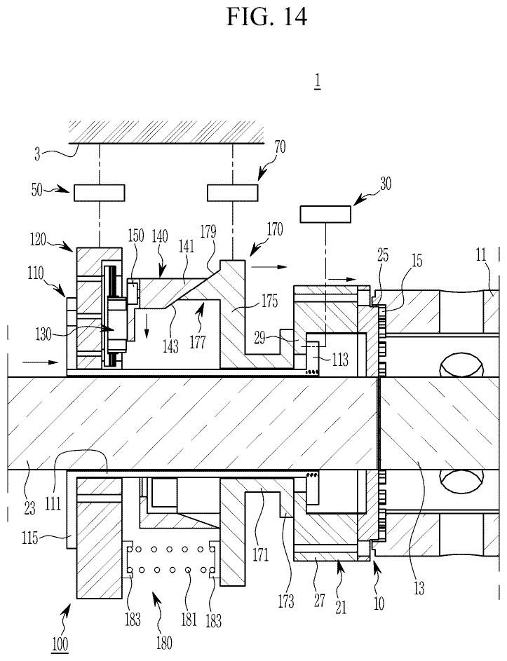

FIGS. 14-17 are drawings for describing the operation of a dog clutch actuator 100 and a dog clutch system 1 including the same according to an embodiment.

Hereinafter, operations of the dog clutch actuator 100 according to an embodiment and the dog clutch system 1 including the same are described in detail referring to FIGS. 1-17.

In an embodiment of the present disclosure, as shown in FIG. 1, the dog clutch housing 11 and the dog clutch moving portion 21 are separated from each other and the dog clutch housing 11 and the dog clutch moving portion 21 are disconnected.

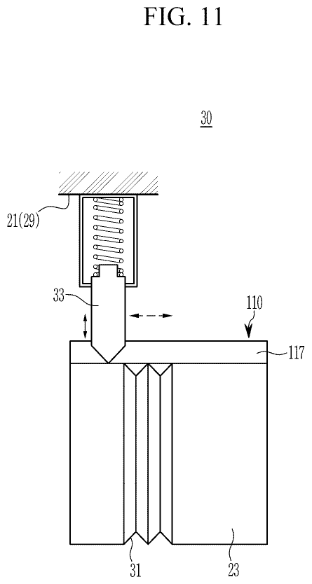

The first gear 15 of the dog clutch housing 11 and the second gear 25 of the dog clutch moving portion 21 are separated from each other, and therefore the power of the first shaft 13 is not transmitted to the second shaft 23. At least one anchor 33 of the clutch fixing unit 30 is in contact with the exterior circumference of the second shaft 23 through at least one slot 117 of the pull sleeve 110 while compressing the anchor spring 37 inside the anchor housing 35, as shown in FIG. 11.

The wedge blocks 140 are moved in the radially outward direction of the base plate 120 along the guide rails 131 via the rail blocks 130.

The cam guide surface 143 of the wedge blocks 140 and the cam follow surface 179 of the slider 170 are in surface contact (or cam contact) on the entire surface. The first shoulder portion 173 of the slider 170 supports the dog clutch moving portion 21.

The pull flange portion 113 of the pull sleeve 110 supports the flange pulling edge 29 of the dog clutch moving portion 21. The support flange portion 115 of the pull sleeve 110 is kept apart from the base plate 120.

As shown in FIG. 12A, the power supply to the shape memory alloy spring 53 of the base fixing portion 50 is cut off. Accordingly, the shape memory alloy spring 53 is in an expanded state.

The base fixing block 51 of the base fixing portion 50 is moved in the outward direction of the base fixing case 57 and is inserted into the base fixing groove 55. The base plate 120 is fixed to the system housing 3 by the base fixing portion 50.

As shown in FIG. 13A, the slider fixing block 71 of the slider fixing portion 70 is inserted into the slider fixing groove 75 while being elastically supported by the spring 73. The slider 170 is fixed to the system housing 3 by the slider fixing portion 70.

In this state, when power delivery of the first shaft 13 and the second shaft 23 is required, current is supplied to the shape memory alloy wire 160 by the control of a controller (e.g., transmission controller) not shown.

When current is supplied to the shape memory alloy wire 160, the shape memory alloy wire 160 reaches the phase transformation temperature through the heat generated by the current, and the shape memory alloy wire 160 shrinks.

When the shape memory alloy wire 160 connected to the base plate 120 and the wedge blocks 140 via the pulleys 150 contracts, as shown in FIG. 14, the wedge blocks 140 move in the radially inward direction of the base plate 120 along the guide rails 131 via the rail blocks 130.

The wedge blocks 140 slide along the cam follow surface 179 of the slider 170 via the cam guide surface 143 and move in the radially inward direction of the base plate 120.

By the cam action of the wedge blocks 140 and the slider 170, the wedge blocks 140 push the slider 170 and move the slider 170 in the dog clutch housing 11 direction.

When the wedge blocks 140 push the slider 170, the slider 170 moves while the base plate 120 is fixed to the system housing 3.

During this process, as shown in FIG. 13B, the slider fixing block 71 moves inwardly of the slider fixing case 77 while compressing the spring 73. The slider fixing block 71 comes into contact with the exterior circumference of the second shoulder portion 175 as it separates or is released from the slider fixing groove 75. In other words, the fixation of the slider 170 to the system housing 3 by the slider fixing portion 70 is released.

Accordingly, when the slider 170 moves as described above, the dog clutch moving portion 21 moves in the direction of the dog clutch housing 11 along the axial direction of the second shaft 23.

Additionally, the slider 170 creates tension in at least one actuator spring 180 while the base plate 120 is stationary and moves in the dog clutch housing 11 direction.

The elastic force (or elastic restoring force) of the actuator spring 180 connected to the base plate 120 and the slider 170 is applied to the slider 170 in the direction opposite to the moving direction of the slider 170.

As the dog clutch moving portion 21 moves in the above process, the flange pulling edge 29 of the dog clutch moving portion 21 pushes the pull flange portion 113, and the pull sleeve 110 moves along the axial direction of the second shaft 23 together with the dog clutch moving portion 21 in the direction of the dog clutch housing 11. Further, the support flange portion 115 of the pull sleeve 110 is in close contact with the base plate 120.

The first gear 15 of the dog clutch housing 11 and the second gear 25 of the dog clutch moving portion 21 are thus engaged, and the dog clutch moving portion 21 rotates together with the dog clutch housing 11. In other words, the power of the first shaft 13 is transmitted to the second shaft 23.

As the dog clutch moving portion 21 moves, as shown in FIG. 12, the anchor 33 moves along the slot 117 of the pull sleeve 110 and is positioned in the locking groove 31, and the anchor 33 is inserted into the locking groove 31 by the elastic force of the anchor spring 37.

The dog clutch moving portion 21 is maintained engaged with the dog clutch housing 11 by the anchor 33.

As described above, when the dog clutch moving portion 21 and the clutch housing 11 are engaged and the current supply to the shape memory alloy wire 160 is cut off, the shape memory alloy wire 160 expands (or relaxes) as it cools.

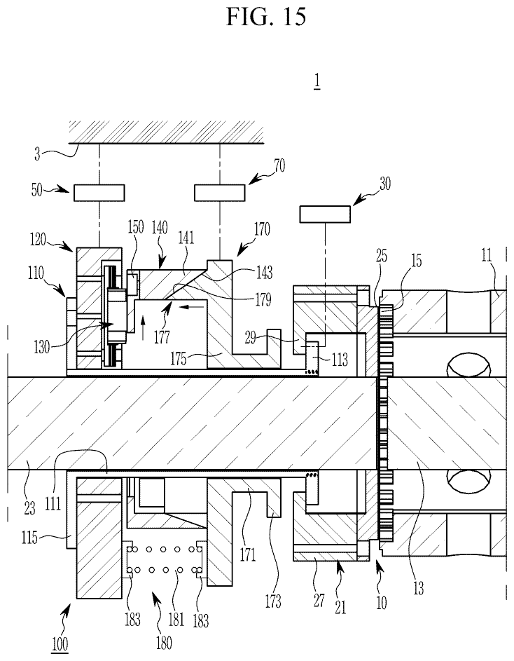

When the shape memory alloy wire 160 connected to the base plate 120 and wedge blocks 140 via the pulleys 150 expands, as shown in FIG. 15, the slider 170 moves in the direction of the base plate 120 by the elastic force (or elastic restoring force) of the actuator spring 180.

When the slider 170 moves in the direction of the base plate 120, as shown in FIG. 13A, the slider fixing block 71 slips or slides on the exterior circumference of the second shoulder portion 175 and is inserted into the slider fixing groove 75 by the elastic restoring force of the spring 73. That is to say, the slider 170 remains fixed to the system housing 3.

As the slider 170 moves in the direction of the base plate 120, the wedge blocks 140 move in the radially outward direction of the base plate 120 along the guide rails 131 via the rail blocks 130.

The wedge blocks 140 slide along the cam follow surface 179 of the slider 170 via the cam guide surface 143 and move in the radially outward direction of the base plate 120. The cam guide surface 143 of the wedge blocks 140 and the cam follow surface 179 of the slider 170 are in surface contact across the entire surface.

Even if the current supply to the shape memory alloy wire 160 is cut off, the engagement of the dog clutch moving portion 21 and the dog clutch housing 11 is not released because the anchor 33 is inserted into the locking groove 31 by the elastic force of the anchor spring 37.

Therefore, according to the dog clutch actuator 100 and the dog clutch system 1 including the same according to an embodiment, energy efficiency can be increased because an additional electric power supply is not required to maintain engagement of the dog clutch moving portion 21 and the dog clutch housing 11.

Additionally, when at least one anchor 33 is inserted into the locking groove 31, the engagement speed of the dog clutch moving portion 21 and the dog clutch housing 11 can be increased by the elastic force of the anchor spring 37.

In the above-described state, if power delivery of the first shaft 13 and the second shaft 23 is not required, current is supplied to the shape memory alloy spring 53 of the base fixing portion 50 under the control of the controller while the slider 170 is fixed to the system housing 3.

Then, as shown in FIG. 12, the shape memory alloy spring 53 contracts due to heat. Accordingly, the base fixing block 51 moves inwardly of the base fixing case 57 and separates from the base fixing groove 55. That is to say, the fixation of the base plate 120 to the system housing 3 by the base fixing portion 50 is released.

Simultaneously, current is supplied to the shape memory alloy wire 160 under the control of the controller.

When current is supplied to the shape memory alloy wire 160, the shape memory alloy wire 160 reaches the phase transformation temperature through the heat generated by the current, and the shape memory alloy wire 160 shrinks.

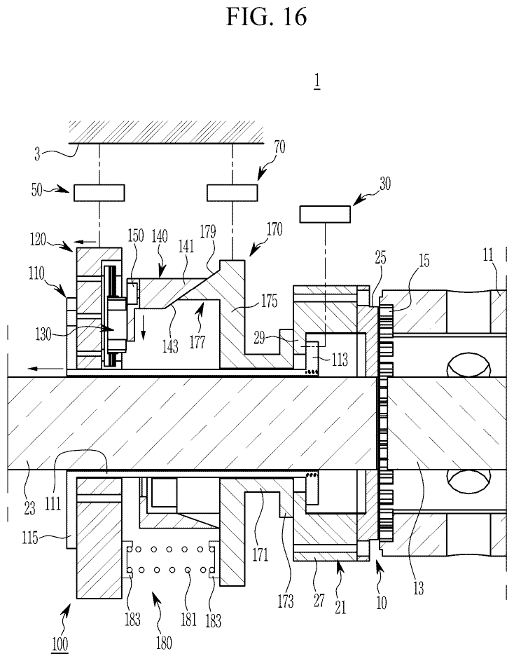

When the shape memory alloy wire 160 connected to the base plate 120 and the wedge blocks 140 via the pulleys 150 contracts, as shown in FIG. 16, the wedge blocks 140 move in the radially inward direction of the base plate 120 along the guide rails 131 via the rail blocks 130.

The wedge blocks 140 slide along the cam follow surface 179 of the slider 170 via the cam guide surface 143 and move in the radially inward direction of the base plate 120.

By the cam action of the wedge blocks 140 and the slider 170, the wedge blocks 140 push the base plate 120, causing the base plate 120 to move to the left in the drawing.

When the wedge blocks 140 push the base plate 120, the base plate 120 moves while the slider 170 is fixed to the system housing 3.

Then, the base plate 120, while the slider 170 is not moving, creates tension in the actuator spring 180 and moves away from the dog clutch housing 11.

The elastic force (or elastic restoring force) of the actuator spring 180 connected to the base plate 120 and the slider 170 is applied to the base plate 120 in a direction opposite to the moving direction of the base plate 120.

The base plate 120 moves and pushes the support flange portion 115, and the pull sleeve 110 moves together with the base plate 120 in the axial direction of the second shaft 23 away from the dog clutch housing 11.

The pull sleeve 110 is in close contact with the base plate 120 through the support flange portion 115 and moves away from the dog clutch housing 11 together with the base plate 120.

The pull flange portion 113 of the pull sleeve 110 pushes the flange pulling edge 29 of the dog clutch moving portion 21. Accordingly, the dog clutch moving portion 21 moves away from the dog clutch housing 11 along the axial direction of the second shaft 23.

Therefore, the dog clutch moving portion 21 is separated from the dog clutch housing 11. Then, the engagement of the first gear 15 of the dog clutch housing 11 and the second gear 25 of the dog clutch moving portion 21 is disengaged, and the power of the first shaft 13 is not transmitted to the second shaft 23.

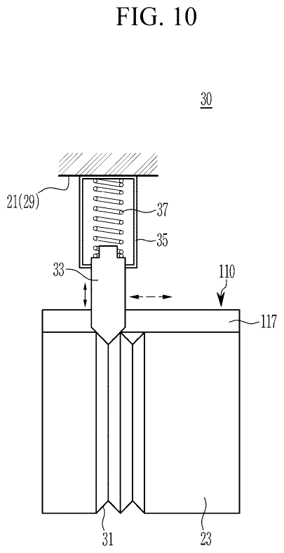

As the dog clutch moving portion 21 moves, as shown in FIG. 10, the anchor 33 disengages from the locking groove 31 and contacts the exterior circumference of the second shaft 23 through the at least one slot 117 of the pull sleeve 110 while compressing the anchor spring 37 inside the anchor housing 35.

As a result, the dog clutch moving portion 21 and the dog clutch housing 11 remain disengaged.

On the other hand, when the current supply to the shape memory alloy wire 160 is cut off while the dog clutch moving portion 21 and the dog clutch housing 11 are disengaged as described above, the shape memory alloy wire 160 expands (or relaxes) as it cools.

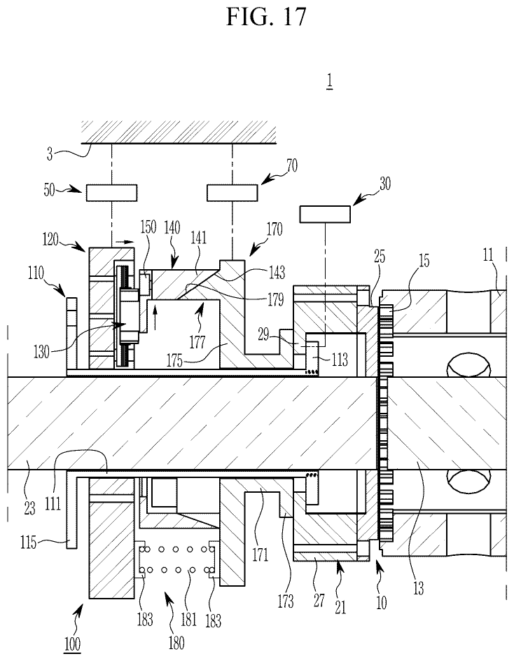

When the shape memory alloy wire 160 connected to the base plate 120 and the wedge blocks 140 via the pulleys 150 expands, as shown in FIG. 17, the base plate 120 moves in the direction of the slider 170 by the elastic force (or elastic restoring force) of the at least one actuator spring 180.

When the base plate 120 moves in the slider 170 direction, the power supplied to the shape memory alloy spring 53 is cut off. Then, as shown in FIG. 12A, the shape memory alloy spring 53 expands, and accordingly, the base fixing block 51 moves in the outward direction of the base fixing case 57 and is inserted into the base fixing groove 55. In other words, the base plate 120 remains fixed to the system housing 3.

As the base plate 120 moves in the slider 170 direction, the wedge blocks 140 move in the radius outward direction of the base plate 120 along the guide rails 131 via the rail blocks 130.

The wedge blocks 140 slide along the cam follow surface 179 of the slider 170 via the cam guide surface 143 and move in the radius outward direction of the base plate 120.

The cam guide surface 143 of the wedge blocks 140 and the cam follow surface 179 of the slider 170 are in surface contact across the entire surface. Further, the support flange portion 115 of the pull sleeve 110 is spaced apart from the base plate 120.

According to the dog clutch actuator 100 embodiments as described herein, and the dog clutch system 1 including the same, it is possible to implement a relatively small and lightweight dog clutch actuator and system because of its simple configuration,

Therefore, according to the disclosed dog clutch actuator 100 and dog clutch system 1, the entire weight can be reduced, space utilization can be improved, and power delivery efficiency can be increased.

In addition, according to the disclosed dog clutch actuator 100 and dog clutch system 1, enhancement of fuel efficiency is possible because no additional power is required to maintain the engagement of the clutch by applying the clutch fixing unit 30.

Although various embodiments of the present disclosure have been described above, the present disclosure is not limited thereto. Various modifications can be made within the scope of the patent claims, the detailed description of the disclosure, and the attached drawings, and it should be apparent that such modifications also fall within the scope of the present disclosure.

<Description of symbols>

| | |
|---|---|
| 1: dog clutch system | 3: system housing |
| 10: dog clutch | 11: dog clutch housing |
| 13: first shaft | 15: first gear |
| 21: dog clutch moving portion | 23: second shaft |
| 25: second gear | 27: outer gear |
| 29: flange pulling edge | 30: clutch fixing unit |
| 31: locking groove | 33: anchor |
| 35: anchor housing | 37: anchor spring |
| 50: base fixing portion | 51: base fixing block |
| 53: shape memory alloy spring | 55: base fixing groove |
| 57: base fixing case | 59, 79: case fixing member |
| 70: slider fixing portion | 71: slider fixing block |
| 73: spring | 75: slider fixing groove |
| 77: slider fixing case | 100: dog clutch actuator |
| 110: pull sleeve | 111: sleeve body |
| 113: pull flange portion | 115: support flange portion |
| 117: slot | 120: base plate |
| 121: connection hole | 130: rail block |
| 131: guide rail | 140: wedge block |
| 141: wedge body | 143: cam guide surface |
| 150: pulley | 160: shape memory alloy wire |
| 170: slider | 171: slide body |
| 173: first shoulder portion | 175: second shoulder portion |
| 177: cam follow portion | 179: cam follow surface |
| 180: actuator spring | 181: tensile coil spring |
| 183: spring seat | |

What is claimed is:

1. A dog clutch actuator comprising:
a pull sleeve movably mounted on a shaft and configured to be movable in an axial direction to push or pull a dog clutch moving portion movably connected to the shaft in the axial direction;
a base plate that is movably mounted to the pull sleeve;
wedge blocks mounted on the base plate and radially movable relative thereto;
a shape memory alloy wire connecting the base plate and the wedge blocks and configured to contract and expand based on whether electric power is supplied thereto to move the wedge blocks;
a slider movably mounted to the pull sleeve, having cam contact with the wedge blocks, configured to push the dog clutch moving portion, and disposed between the wedge blocks and the dog clutch moving portion; and
at least one actuator spring elastically connecting the base plate and the slider.

2. The dog clutch actuator of claim 1, further comprising pulleys rotatably mounted on each of the base plate and the wedge blocks on which the shape memory alloy wire is wound.

3. The dog clutch actuator of claim 2, further comprising rail blocks that are connected to the base plate and slidable in a radial direction relative thereto.

4. The dog clutch actuator of claim 3, wherein each of the wedge blocks comprises:
a wedge body connected to a respective one of the rail blocks and on which a corresponding one of the pulleys is rotatably mounted; and
a cam guide surface inclined in a diagonal direction on the wedge body.

5. The dog clutch actuator of claim 1, wherein the pull sleeve comprises:
a sleeve body of a cylinder shape that is slidably mounted on the shaft;
a pull flange portion at one end of the sleeve body and in contact with the dog clutch moving portion; and
a support flange portion at the other end of the sleeve body to push the base plate.

6. The dog clutch actuator of claim 1, wherein the slider comprises:
a slide body that is slidably connected to the pull sleeve;
a first shoulder portion at one end of the slide body to push the dog clutch moving portion;
a second shoulder portion at the other end of the slide body; and
a cam follow portion on the second shoulder portion to cam contact with the wedge blocks.

7. The dog clutch actuator of claim 6, wherein the slider includes multiple cam follow portions and wherein each of the cam follow portions comprises a cam follow surface contacting a cam guide surface on a corresponding one of the wedge blocks.

8. The dog clutch actuator of claim 1, wherein the actuator spring comprises a tensile coil spring fixed to the base plate and the slider.

9. The dog clutch actuator of claim 1, wherein the shape memory alloy wire contracts due to heat based on power being supplied thereto and expands due to cooling when the power being supplied is cut off.

10. A dog clutch system comprising:
a dog clutch housing connected to a first shaft and having a first gear therein;
a dog clutch moving portion movably connected to a second shaft arranged coaxially with the first shaft and having a second gear selectively engaging the first gear; and
a dog clutch actuator of the claim 1 installed on the second shaft.

11. The dog clutch system of claim 10, wherein:
the first gear is a housing clutch dog on an inner periphery of the dog clutch housing; and
the second gear is a moving portion clutch on an exterior circumference of the dog clutch moving portion.

12. The dog clutch system of claim 10, wherein the dog clutch moving portion comprises a flange pulling edge that contacts the pull sleeve of the dog clutch actuator.

13. The dog clutch system of claim 10, further comprising a clutch fixing unit installed on the dog clutch moving portion and configured to limit the movement of the dog clutch moving portion when the first gear and the second gear are engaged.

14. The dog clutch system of claim 13, wherein the clutch fixing unit comprises:
a locking groove on an exterior circumference of the second shaft; and
at least one anchor configured to be selectively inserted into the locking groove.

15. The dog clutch system of claim 14, wherein the at least one anchor is configured to reside in a slot disposed along the length direction of the pull sleeve of the dog clutch actuator.

16. The dog clutch system of claim 14, wherein the clutch fixing unit further comprises:
an anchor housing fixed to the dog clutch moving portion; and
an anchor spring disposed in the anchor housing and configured to elastically support the at least one anchor.

17. The dog clutch system of claim 10, further comprising:
a base fixing portion installed in a system housing of the dog cutch system to selectively fix the base plate of the dog clutch actuator; and
a slider fixing portion installed in the system housing to selectively fix the slider of the dog clutch actuator.

18. The dog clutch system of claim 17, wherein the base fixing portion comprises:
a base fixing block, which is selectively movable into at least one base fixing groove in an exterior circumference of the base plate and which is movably mounted in at least one base fixing case fixed to the system housing; and
a shape memory alloy spring connected to the base fixing case and the base fixing block, the shape memory allow spring disposed inside the base fixing case and configured to to contract and expand based on whether power is supplied thereto.

19. The dog clutch system of claim 17, wherein the slider fixing portion comprises:
a slider fixing block, which is selectively inserted into at least one slider fixing groove in an exterior circumference of the slider and which is movably mounted in at least one slider fixing case fixed to the system housing; and
a spring disposed inside the slider fixing case and connected to the slider fixing case and the slider fixing block.
